(19) United States
(12) Patent Application Publication
(10) Pub. No.: US 2008/0193809 A1
(43) Pub. Date: Aug. 14, 2008

(54) Hydrogen generating apparatus and fuel cell power generation system

(75) Inventors: Jae-Hyoung Gil, Seoul (KR); Jae-Hyuk Jang, Seongnam-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/812,523

(22) Filed: Jun. 19, 2007

(30) Foreign Application Priority Data
Feb. 14, 2007 (KR) 10-2007-0015552

(51) Int. Cl. H01M 8/18

(52) U.S. Cl. 429/21

(57) ABSTRACT

An aspect of the present invention features a hydrogen generating apparatus. The apparatus can comprise an electrolyzer that is filled with an aqueous electrolyte solution containing hydrogen ions; a first electrode that is accommodated in the electrolyzer, submerged in the aqueous electrolyte solution, and generates electrons; a second electrode that is accommodated in the electrolyzer, submerged in the aqueous electrolyte solution, and receives the electrons to generate hydrogen; and a control unit that is disposed between the first electrode and the second electrode, and controls the amount of electrons transferred from the first electrode to the second electrode. The hydrogen generating apparatus according to the present invention can control the amount of hydrogen generation by controlling the amount of the electric current between electrodes according to the demand of a user or a fuel cell. Therefore, the present invention can be applied to a mobile device, in which power consumption varies depending on circumstances.

### CROSS-REFERENCE TO RELATED APPLICATIONS

This application claims the benefit of Korean Patent Application No. 10-2007-0015552 filed with the Korean Intellectual Property Office on Feb. 14. 2007., the disclosures of which are incorporated herein by reference in their entirety.

### BACKGROUND

1. Technical Field

The present invention relates to a hydrogen generating apparatus, more particularly to a hydrogen generating apparatus that can control the amount of generation of hydrogen supplied to a fuel cell.

2. Description of the Related Art

A fuel cell refers to an energy conversion apparatus that directly converts chemical energy of a fuel (hydrogen, LNG, LPG, methanol, etc.) and air to electricity and/or heat by means of an electrochemical reaction. Unlike a conventional power generation technology that requires fuel combustion, steam generation, or a turbine or power generator, the fuel cell technology needs no combustion process or driving device, thereby boosting energy efficiency and curbing environmental problems.

FIG. 1 illustrates an operational architecture of a fuel cell.

Referring to FIG. 1, a fuel cell 100 is composed of an anode as a fuel pole 110 and a cathode as an air pole 130. The fuel pole 110 is provided with hydrogen molecules (H₂), and decomposes them into hydrogen ions (H⁺) and electrons (e⁻). The hydrogen ion (H⁺) moves toward the air pole 130 via a membrane 120, which is an electrolyte layer. The electron moves through an external circuit 140 to generate an electric current. In the air pole 130, the hydrogen ions and the electrons are combined with oxygen molecules in the atmosphere, generating water molecules. The following chemical formulas represent the above chemical reactions occurring in the fuel cell 100.

CHEMICAL FORMULA 1

Fuel pole 110: H₂→2H⁺+2e⁻

Air pole 130: ½O₂+2H⁺+2e⁻→H₂O

Overall reaction: H₂+½O₂→H₂O

In short, the fuel cell 100 functions as a battery by supplying the electric current, generated due to the flowing of the decomposed electrons, to the external circuit 140. Such a fuel cell 100 hardly emits an atmospheric pollutant such as Sox and NOx and makes little noise and vibration.

Meanwhile, in order to produce electrons in the fuel pole 110, the fuel cell 100 necessitates a hydrogen generating apparatus that can change a common fuel to hydrogen gas.

A hydrogen storage tank, generally known as a hydrogen generating apparatus, however, occupies a large space and should be kept with care.

Moreover, as a portable electronic device, such as a mobile phone and a notebook computer, requires a large capacity of power, it is necessary that the fuel cell have a large capacity and perform high performance while it is small.

In order to meet the above needs, methanol or formic acid, permitted to be brought into an airplane by International Civil Aviation Organization (ICAO), is used for fuel reforming, or methanol, ethanol, or formic acid is directly used as a fuel for the fuel cell.

However, the former case requires a high reforming temperature, has a complicated system, consumes driving power, and contains impurities (e.g., CO₂ and CO) in addition to pure hydrogen. The latter case deteriorates power density due to a low rate of a chemical reaction in the anode and a cross-over of hydrocarbon through the membrane.

### SUMMARY

The present invention provides a hydrogen generating apparatus that can generate hydrogen by using an environment-friendly material instead of a BOP (Balance of Plant) unit consuming separate power and difficult to be miniaturized.

Also, the present invention provides a cost-effective hydrogen generating apparatus that can have a simple structure and generate pure hydrogen under room temperature by using an electrochemical reaction.

In addition, the present invention provides a hydrogen generating apparatus that can control the amount of hydrogen generation by controlling the amount of the electric current between electrodes according to the demand of a user or a fuel cell. Therefore, the present invention can be applied to a mobile device, in which power consumption varies depending on circumstances.

An aspect of the present invention features a hydrogen generating apparatus. The apparatus can comprise an electrolyzer that is filled with an aqueous electrolyte solution containing hydrogen ions; a first electrode that is accommodated in the electrolyzer, submerged in the aqueous electrolyte solution, and generates electrons; a second electrode that is accommodated in the electrolyzer, submerged in the aqueous electrolyte solution, and receives the electrons to generate hydrogen; and a control unit that is disposed between the first electrode and the second electrode, and controls the amount of electrons transferred from the first electrode to the second electrode.

The control unit can control the amount of electrons in accordance with information inputted by a user.

The hydrogen generating apparatus can be coupled with a fuel cell, to which the hydrogen is supplied, and the control unit controls the amount of electrons in accordance with information on the amount of hydrogen or power demanded for the fuel cell.

A metal forming the first electrode can have a higher ionization tendency than a metal forming the second electrode.

The first electrode or the second electrode can be disposed in plural number.

Another aspects of the present invention features a fuel cell power generation system can comprise a hydrogen generating apparatus that controls the amount of hydrogen generation by adjusting the amount of electrons transferred between electrodes; and a fuel cell that receives hydrogen generated in the hydrogen generating apparatus, and produces a direct current by converting chemical energy of the hydrogen to electric energy.

The hydrogen generating apparatus can comprise an electrolyzer that is filled with an aqueous electrolyte solution containing hydrogen ions; a first electrode that is accommodated in the electrolyzer, submerged in the aqueous electrolyte solution, and generates electrons; a second electrode that is accommodated in the electrolyzer, submerged in the aqueous electrolyte solution, and generates hydrogen by receiving the electrons; and a control unit that is disposed between the first electrode and the second electrode, and controls the amount of electrons transferred from the first electrode to the second electrode.

The control unit can control the amount of the electrons in accordance with information inputted by a user.

The control unit can control the amount of electrons in accordance with information on the amount of hydrogen or power demanded for the fuel cell.

A metal forming the first electrode can have a higher ionization tendency than a metal forming the second electrode.

The first electrode or the second electrode can be disposed in plural number.

Additional aspects and advantages of the present general inventive concept will be set forth in part in the description which follows, and in part will be obvious from the description, or may be learned by practice of the general inventive concept.

### BRIEF DESCRIPTION OF THE DRAWINGS

These and other features, aspects, and advantages of the present invention will become better understood with regard to the following description, appended claims, and accompanying drawings where:

FIG. 1 illustrates an operational architecture of a fuel cell;

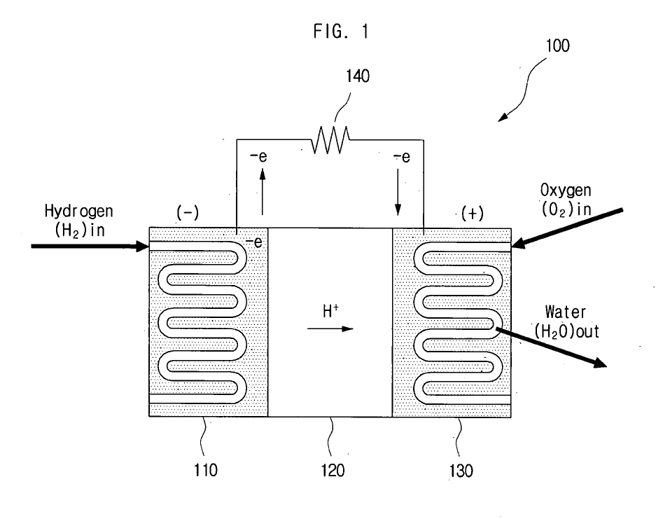

FIG. 2 shows a sectional view of a hydrogen generating apparatus in accordance with an embodiment of the present invention;

FIG. 3 is a graph showing how the amount of electric current between a first electrode and a second electrode and the amount of generated hydrogen are related in a hydrogen generating apparatus in accordance with an embodiment of the present invention.

### DETAILED DESCRIPTION

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, certain embodiments will be described in detail with reference to the accompanying drawings. Identical or corresponding elements will be given the same reference numerals, regardless of the figure number, and any redundant description of the identical or corresponding elements will not be repeated.

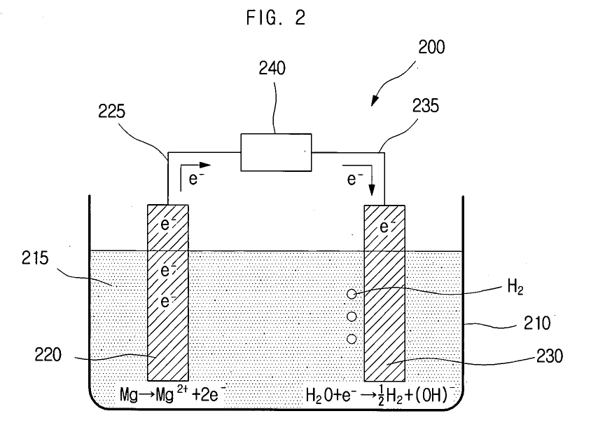

FIG. 2 is a sectional view of a hydrogen generating apparatus in accordance with an embodiment of the present invention.

A hydrogen generating apparatus 200 includes an electrolyzer 210, a first electrode 220, a second electrode 230 and a control unit 240. For the convenience of description and understanding, it will be presumed below that the first electrode 220 is composed of magnesium (Mg) and the second electrode 230 is composed of stainless steel.

The electrolyzer 210 is filled with an aqueous electrolyte solution 215. The aqueous electrolyte solution 215 contains hydrogen ions, which are used by the hydrogen generating apparatus 200 to generate hydrogen gas.

Examples of the electrolyte for the aqueous electrolyte solution 215 are LiCl, KCl, NaCl, KNO₃, NaNO₃, CaCl₂, MgCl₂, K₂SO₄, Na₂SO₄, MgSO₄, AgCl, or the like.

The electrolyzer 210 accommodates the first electrode 220 and the second electrode 230, the entirety or portions of which are submerged in the electrolyte solution 215.

The first electrode 220 is an active electrode, where the magnesium (Mg) is oxidized to magnesium ions (Mg²⁺), releasing electrons due to the difference in ionization energies of magnesium and water. The released electrons move to the second electrode 230 through a first electric wire 225, the control unit 240 and a second electric wire 235.

The second electrode 230 is an inactive electrode, where the water molecules receive the electrons moved from the first electrode 220 and then are decomposed into the hydrogen molecules.

The above chemical reactions can be represented as the following chemical formula 2:

CHEMICAL FORMULA 2

First electrode 220: Mg→Mg²⁺+2e⁻

Second electrode 230: 2H₂O+2e⁻→H₂+2(OH)⁻

Overall reaction: Mg+2H₂O→Mg(OH)₂+H₂

The reaction rate and the efficiency of the chemical reaction depend on various factors, including the area of the first electrode 220 and/or the second electrode 230, the concentration of the aqueous electrolyte solution 215, the type of the aqueous electrolyte solution 215, the number of the first electrode 220 and/or the second electrode 230, the method of connecting the first electrode 220 and the second electrode 230, the electric resistance between the first electrode 220 and the second electrode 230.

Changing any of the above factors affects the amount of electric current (that is, the amount of electrons) flowing between the first electrode 220 and the second electrode 230, thereby altering the reaction rate of the electrochemical reaction shown in CHEMICAL FORMULA 2, which in turn changes the amount of hydrogen generated in the second electrode 230.

Therefore, the amount of the hydrogen generated in the second electrode 230 can be controlled by controlling the amount of the electric current that flows between the first electrode 220 and the second electrode 230. Faraday's law explains this as shown in MATHEMATICAL FORMULA 1 below.

$${N}_{hydrogen} = \frac{i}{nE} \\ {N}_{hydrogen} = \frac{i}{2 \times 96485} ( mol ) \\ \begin{matrix}{V}_{hydrogen} = \frac{i}{2 \times 96485} \times 60 \times 22400 ( ml / min ) \\ = 7 \times i ( ml / min )\end{matrix} \qquad MATHEMATICAL FORMULA 1$$

where N_{hydrogen} is the amount of hydrogen generated per second (mol/s), V_{hydrogen} is the volume of hydrogen generated per minute (ml/min), i is the electric current (C/s), n is the number of the reacting electrons, and E is the electron charge per mole (C/mol).

In the case of the above CHEMICAL FORMULA 2, n has a value of 2 since two electrons react at the second electrode 230, and E has a value of −96,485 C/mol.

The volume of hydrogen generated per minute can be calculated by multiplying the time (60 seconds) and the molar volume of hydrogen (22400 ml) to the amount of hydrogen generated per second.

For example, in the case that the fuel cell is used in a 2 W system, it takes 42 ml/mol of hydrogen and 6 A of electric current. However, in the case that the fuel cell is used in a 5 W system, it takes 105 ml/mol of hydrogen and 15 A of electric current.

The hydrogen generating apparatus 200 can meet the variable hydrogen demand of the fuel cell connected thereto by controlling the amount of electric current flowing through the first electric wire 225, connected to the first electrode 220, and the second electric wire 235, connected to the second electrode 230.

However, most of the factors that determine the rate of the hydrogen generation reaction occurring in the second electrode of the hydrogen generating apparatus 200, except the electric resistance between the first electrode 220 and the second electrode 230, are hardly changeable once the hydrogen generating apparatus 200 is manufactured.

Therefore, the hydrogen generating apparatus 200 according to this embodiment of the present invention has the control unit 240 disposed between the first electric wire 225 and the second electric wire 235, which connect the first electrode 220 and the second electrode 230, in order to regulate the electric resistance between the first electrode 220 and the second electrode 230.

Thus, the hydrogen generating apparatus 200 controls the electric resistance between the first electrode 220 and the second electrode 230, that is, the amount of the electric current flowing therebetween, thereby generating as much hydrogen as needed by the fuel cell.

The first electrode 220 can be also composed of a metal having a relatively high ionization tendency, such as iron (Fe), aluminium (Al), zinc (Zn), or the like. The second electrode 230 can be also composed of a metal having a relatively low ionization tendency compared to the metal of the first electrode 220, such as platinum (Pt), aluminum (Al), copper (Cu), gold (Au), silver (Ag), iron (Fe), or the like.

The control unit 240 controls a transfer rate, that is, the amount of electric current, at which electrons generated in the first electrode 220 are transferred to the second electrode 230.

The control unit 240 receives information on the amount of power or hydrogen demanded for the fuel cell and, according to the information, controls the amount of electrons flowing from the first electrode 220 to the second electrode 230. If the demanded amount of power or hydrogen is large, the control unit 240 increases the amount of electrons, and the control unit 240 reduces the amount of the electrons if the demanded amount of power or hydrogen is small.

For example, the control unit 240 includes an adjustable resistor as its component, and controls the resistance of the adjustable resistor, thereby adjusting the amount of the electric current flowing between the first electrode 220 and the second electrode 230. For another example, the control unit 240 has an ON/OFF switch, which controls a timing of on/off operation, thereby adjusting the amount of the electric current between the first electrode 220 and the second electrode 230.

The hydrogen generating apparatus 200 can receive the information on the amount of the power or the hydrogen demanded for the fuel cell from the fuel cell combined with the hydrogen generating apparatus 200 or from a user, who inputs the information through a separate input unit.

The hydrogen generating apparatus of the present invention can have a plurality of the first electrodes 220 and/or the second electrodes 230. In the case that a plural number of the first electrode 220 and/or the second electrode 230 are disposed, it can take a shorter time to generate the demanded amount of hydrogen since the hydrogen generating apparatus 200 can generate more hydrogen per unit time.

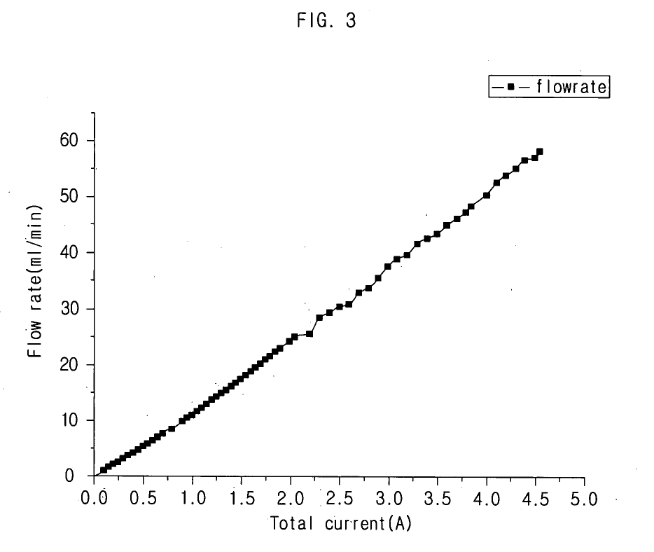

FIG. 3 is a graph showing how the amount of electric current flowing between the first electrode 220 and the second electrode 230 is related to the volume of hydrogen generated on the second electrode 230. Here, it should be noted that the volume of hydrogen is shown in flow-rate measured per minute, because not the total volume of generated hydrogen but the flow-rate of hydrogen is significant to a fuel cell.

An experiment for FIG.3 was conducted under the following conditions:

First electrode 220: Magnesium (Mg)

Second electrode 230: Stainless steel

Distance between the electrodes: 3 mm

Ingredients and concentration of electrolyte: 30 wt % KCl

Nnumber of the electrodes: Magnesium 3 each, Stainless steel 3each

Electrode connecting method: Serial

Volume of aqueous electrolyte solution: 60 cc (excessive condition)

Size of the electrode: 24 mm×85 mm×1 mm

FIG. 3 shows a greater flow rate of the hydrogen than a theoretical value based on MATHEMATICAL FORMULA 1, due to an interaction of the three pairs of electrodes.

Nevertheless, it is verified from FIG. 3 that the flow-rate of hydrogen is correlated with the amount of electric current between the first electrode 220 and the second electrode 230. Also, the graph shows an almost linear relation between the flow-rate and the amount of the electric current, which agrees with the MATHEMATICAL FORMULA 1.

While the invention has been described with reference to the disclosed embodiments, it is to be appreciated that those skilled in the art can change or modify the embodiments without departing from the scope and spirit of the invention or its equivalents as stated below in the claims.

What is claimed is:

1. A hydrogen generating apparatus comprising:
an electrolyzer that is filled with an aqueous electrolyte solution containing hydrogen ions;
a first electrode that is accommodated in the electrolyzer, submerged in the aqueous electrolyte solution, and generates electrons;
a second electrode that is accommodated in the electrolyzer, submerged in the aqueous electrolyte solution, and receives the electrons to generate hydrogen; and
a control unit that is disposed between the first electrode and the second electrode, and controls the amount of electrons transferred from the first electrode to the second electrode.

2. The hydrogen generating apparatus of claim 1, wherein the control unit controls the amount of electrons in accordance with information inputted by a user.

3. The hydrogen generating apparatus of claim 1, wherein the hydrogen generating apparatus is coupled with a fuel cell, to which the hydrogen is supplied; and the control unit controls the amount of electrons in accordance with information on the amount of hydrogen or power demanded for the fuel cell.

4. The hydrogen generating apparatus of claim 1, wherein a metal forming the first electrode has a higher ionization tendency than a metal forming the second electrode.

5. The hydrogen generating apparatus of claim 1, wherein the first electrode or the second electrode is disposed in plural number.

6. A fuel cell power generation system comprising:
a hydrogen generating apparatus that controls the amount of hydrogen generation by adjusting the amount of electrons transferred between electrodes; and
a fuel cell that receives hydrogen generated in the hydrogen generating apparatus, and produces a direct current by converting chemical energy of the hydrogen to electric energy.

7. The system of claim 6, wherein the hydrogen generating apparatus comprises an electrolyzer that is filled with an aqueous electrolyte solution containing hydrogen ions;
a first electrode that is accommodated in the electrolyzer, submerged in the aqueous electrolyte solution, and generates electrons;
a second electrode that is accommodated in the electrolyzer, submerged in the aqueous electrolyte solution, and generates hydrogen by receiving the electrons; and
a control unit that is disposed between the first electrode and the second electrode, and controls the amount of electrons transferred from the first electrode to the second electrode.

8. The system of claim 7, wherein the control unit controls the amount of the electrons in accordance with information inputted by a user.

9. The system of claim 7, wherein the control unit controls the amount of electrons in accordance with information on the amount of hydrogen or power demanded for the fuel cell.

10. The system of claim 7, wherein a metal forming the first electrode has a higher ionization tendency than a metal forming the second electrode.

11. The system of claim 7, wherein the first electrode or the second electrode is disposed in plural number.
